(19) United States
(12) Patent Application Publication
(10) Pub. No.: US 2015/0329289 A1
(43) Pub. Date: Nov. 19, 2015

(54) Subterranean Sealed Bore Fuel System

(71) Applicants: Ronald R. Mercer, Nichols Hills, OK (US); John Herbert Bolte, Joplin, MO (US); Anthony Richard Tiehen, Oklahoma City, OK (US)

(72) Inventors: Ronald R. Mercer, Nichols Hills, OK (US); John Herbert Bolte, Joplin, MO (US); Anthony Richard Tiehen, Oklahoma City, OK (US)

(21) Appl. No.: 14/713,481

(22) Filed: May 15, 2015

Related U.S. Application Data
(60) Provisional application No. 61/993,459, filed on May 15, 2014.

(51) Int. Cl. B65G 5/00; G05B 13/04

(52) U.S. Cl. CPC B65G 5/00; G05B 13/048

(57) ABSTRACT

A system for storing fuel in and delivering fuel from a subterranean sealed bore may have at least one subterranean sealed bore connected to at least one compressor and one or more control circuits to store natural gas at a predetermined pressure. Each subterranean sealed bore can consist of a casing string extending a predetermined depth below ground. The one or more control circuits may consist of a log of activity in each subterranean sealed bore and a prediction model compiled in response to the log of activity.

### RELATED APPLICATION

The present application makes a claim of domestic priority to U.S. Provisional Patent Application No. 61/993,459 filed May 15, 2014, the contents of which are hereby incorporated by reference.

### SUMMARY

A fuel storage and delivery system, in accordance with some embodiments, has at least one subterranean sealed bore connected to at least one compressor and one or more control circuits to store natural gas at a predetermined pressure. Each subterranean sealed bore has a casing string extending a predetermined depth below ground. The one or more control circuits collect a log of activity in each subterranean sealed bore and compile a prediction model in response to the log of activity.

### BRIEF DESCRIPTION OF THE DRAWINGS

FIG. 1 is a block representation of a portion of an example subterranean sealed bore fuel system constructed and operated in accordance with various embodiments.

FIG. 2 illustrates a top view line representation of an example fuel system environment in which the subterranean sealed bore fuel system of FIG. 1 may be employed.

FIG. 3 is a line representation of an example subterranean sealed bore fuel system configured in accordance with some embodiments.

FIG. 4 shows a cross-sectional line representation of a portion of an example subterranean sealed bore fuel system constructed in accordance with various embodiments.

FIGS. 5A and 5B respectively display cross-section and top view line representations of an example casing coupling capable of being utilized in a subterranean sealed bore fuel system.

FIG. 6 is an example compressor activation scheme that may be conducted in accordance with some embodiments.

FIG. 7 provides an example filling trend generation routine carried out in accordance with assorted embodiments.

FIG. 8 shows a line representation of a portion of an example system with multiple subterranean sealed bores configured in accordance with various embodiments.

FIG. 9 illustrates a line representation of an example cryogenic subterranean fuel system arranged in accordance with assorted embodiments.

FIG. 10 displays a block representation of an example intelligent fuel dispenser that may be employed in a subterranean sealed bore fuel system in accordance with some embodiments.

FIG. 11 provides a flowchart of an example gasoline gas equivalent filling routine that may be carried out in accordance with various embodiments.

FIG. 12 diagrams an example subterranean sealed fuel system configured in accordance with some embodiments.

FIG. 13 displays an example subterranean sealed fuel system configured in accordance with some embodiments.

FIG. 14 is a cross-sectional line representation of an example subterranean sealed bore capable of being utilized in a fuel system in accordance with assorted embodiments.

FIG. 15 shows a cross-sectional line representation of an example subterranean sealed bore constructed in accordance with some embodiments.

FIG. 16 illustrates a line representation of a portion of an example subterranean sealed bore fuel system arranged in accordance with various embodiments.

FIG. 17 provides a cross-sectional line representation of a portion of an example subterranean sealed bore that can be incorporated into a fuel system in accordance with assorted embodiments.

### DETAILED DESCRIPTION

Continued rises in fuel prices have prompted increased interest in compressed natural gas (CNG) and liquefied natural gas (LNG) as a fuel source for recreational, commercial, and industrial applications. With CNG being a gas under pressure as opposed to unpressurized liquid fuels, like gasoline and diesel, relatively large storage containers are needed to provide practical CNG service. The common pressurization of CNG containers to thousands of pounds per square inch (psi) corresponds with the containers being constructed with high wall thicknesses, such as between 1.5″-3.5″. The combination of large size and high wall thickness results in a CNG container being very expensive and difficult to position in high population density environments. Also, utilization of a CNG vessel combined with adsorption based systems, such as systems with an approximately 800 psi low pressure and approximately 200,000 cubic feet capacity, are difficult to commercially implement. That is, multiple compressors are needed to raise pressure in an adsorption based system to 3600 psi with enough fuel volume to efficiently fill multiple vehicles. Hence, there is an industry and consumer goal of finding alternative manners of storing and delivering CNG fuel.

Accordingly, natural gas fuel can be stored in and delivered from at least one subterranean sealed bore connected to at least one compressor and one or more control circuits to store natural gas at a predetermined pressure with each subterranean sealed bore having a casing string extending a predetermined depth below ground. The one or more control circuits collect a log of activity in each subterranean sealed bore and compile a prediction model in response to the log of activity. The ability to store natural gas fuel below ground eliminates costly and bulky above ground storage tanks while providing reduced temperature volatility compared to the above ground tanks due to the insulating nature of ground formations. Moreover, the oil exploration bores and casings have very high pressure tolerances that provide a heightened level of safety compared to above ground tanks to allow the control circuitry to maintain at least a predetermined fueling rate and/or pressure with a subterranean bore.

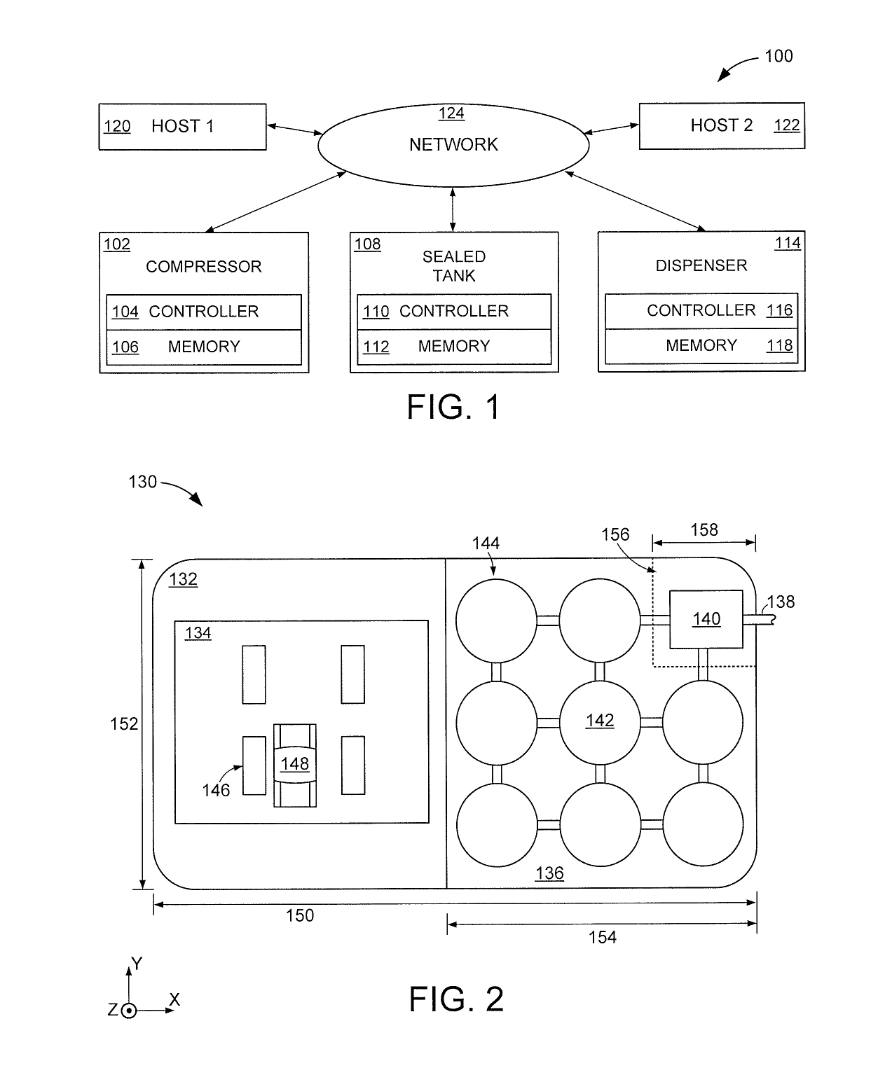

Although storage of natural gas below ground can be configured in an unlimited variety of manners, various embodiments utilize the subterranean sealed bore fuel system 100 shown in FIG. 1 to store and deliver liquefied and compressed natural gas. The fuel system 100 can have at least one compressor 102 that employs one or more local controllers 104, such as a control circuit, and memory arrays 106 to transition gas from an inlet pressure to an elevated outlet pressure. In various embodiments, the compressor 102 operates local software via the controller 104 and memory 106 to conduct optimized compression of natural gas and detection of faults with a number of sensors.

Controlled operation of the compressor 102 can provide gas at a predetermined volume and pressure that is stored in a sealed tank 108. It is contemplated that the sealed tank 108 has a spherical or cylindrical and is mounted completed above ground, which may be above or below sea level. The sealed tank 108 may be constructed of a variety of materials, such as steel, carbon fiber, and combinations thereof, none of which are required or limiting. The sealed tank 108 may have one or more controllers 110, such as a microprocessor control circuit, and local data memory 112 that measures, detects, and stores conditions in and around the sealed tank. For example, the controller 110 can log pressure changes within the sealed tank 108 for a variety of external temperatures.

The sealed tank 108 may be incorporated into an array of interconnected tanks, valves, and piping that provides increased volumes of gas storage and complexity compared to a single sealed tank 108. One or more sealed tanks 108 may service at least one filling dispenser 114 that can selectively provide predetermined volumes of compressed gas at a predetermined pressure to a terminal, such as a motor vehicle, mobile storage tank, and industrial equipment. The filling dispenser 114 may be configured to utilize at least one controller 116, such as a control circuit, and local memory 118 to intelligently service a connected terminal. For instance, the controller 116 may execute software stored in the local memory 118 to provide a gas at a consistent volume and pressure by adapting to the number and type of service requests received.

While the compressor 102, sealed tank 108, and filling dispenser 114 may be controlled locally to operate individually, various embodiments utilize different first 120 and second 122 remote hosts to access, control, and modify the structure and function of the local components via a network 124. It is contemplated that the network 124 can be wired, wireless, and a combination thereof that connects the hosts 120 and 122 to the local controllers 104, 110, and 116 of the various fuel system 100 components. Such connections can allow for remote monitoring of field conditions, equipment status, and operating performance of the compressor 102, sealed tank 108, and filling dispenser 114 individually and collectively.

The ability to remotely access and control the various fuel system 100 components may further allow for the utilization of greater computing power to process data from the fuel system 100 as a whole to provide system status and optimize system performance. As a non-limiting example, one or more remote hosts 120 and 122 can adjust filling dispenser 114 operation in response to predicted use based on data from the compressor 102 and/or the sealed tank 108. Though the fuel system 100 may provide optimized performance via remote and local data compilation and control, structural and business limitations may remain for the efficient storage and delivery of fuel.

FIG. 2 illustrates a top view line representation of an example fuel environment 130 in which the fuel system 100 of FIG. 1 may be employed in accordance with assorted embodiments. The fuel environment 130 may consist of one or more connected or isolated land plots 132 on which fuel is to be stored and dispensed to motor vehicles, such as consumer, commercial, and industrial cars and trucks.

As shown, the land plots 132 contain a dispensing 134 and storage 136 regions that respectively store fuel and deliver fuel, such as CNG and LNG, at predetermined volumes and pressures. The storage region 136 may be serviced by one or more utility lines 138 that provide gas at a relatively low pressure before at least one compressor 140 increases the pressure of the gas that is subsequently stored in a sealed tank 142. It is contemplated that the sealed tanks 142 may be interconnected and organized to provide gas at a single pressure as well as multiple different pressures, such as with banks 144 comprising a plurality of tanks 142. The sealed tanks 142 can be individually and collectively accessed by at least one filling dispensers 146 to deliver fuel to one or more motor vehicles 148.

Although the storage and delivery of fuel in environments configured like environment 130 can service motor vehicles 148, the use of the land plots 132 and cost of equipment can be grossly inefficient. In the example shown in FIG. 2, the overall area of the land plots 132, as defined by the length 150 and height 152, available to house filling dispensers 146 and service motor vehicles 148 is reduced by the storage area defined by length 154 and height 152. That is, the storage area 136 is large due to the number and size of the sealed tanks 142, which impedes on the area available to deliver fuel. In addition, storing fuel at relatively high pressures, such as 5,000 psi, in the sealed tanks 142 can correspond with vessels that are expensive to build and install.

In contrast, storing fuel below ground can reduce the storage area 136 to the compressor section 156 defined by segmented lines. In other words, the storage of fuel underground can reduce and eliminate the above ground footprint of the storage region 136 to the compressor section 156, which can be as small as a single compressor 140. Such reduced area of the storage region 136 can allow more filling dispensers 146 with a reduced length 158, motor vehicle 148 capacity, and space to develop retail structures that can produce income. Accordingly, the reduction and elimination of above ground sealed tanks 142 can optimize the use of land and the business efficiency of the fuel environment 130.

It should be noted that it is not safe nor always feasible to position an above ground sealed tank 142 below ground. For instance, an above ground sealed tank 142 can have vents and drains that operate exclusively above ground. Moreover, the material construction of above ground tanks can be susceptible to corrosion over time that can be difficult to detect below ground and pose hazards for the fuel environment 130 and its surroundings.

It is further noted that the storage capacity of an above ground sealed tank 142 can be limited by weight and size to store roughly 100 gasoline gallon equivalent (gge) of fuel or less. Such volume limitations are compounded by the cost of fabrication of an above ground sealed tank 142 being approximately $30,000. Thus, the example storage region 136 of FIG. 2 can have a storage tank equipment cost of roughly $240,000, which does not account for costs associated with installation and service over time.

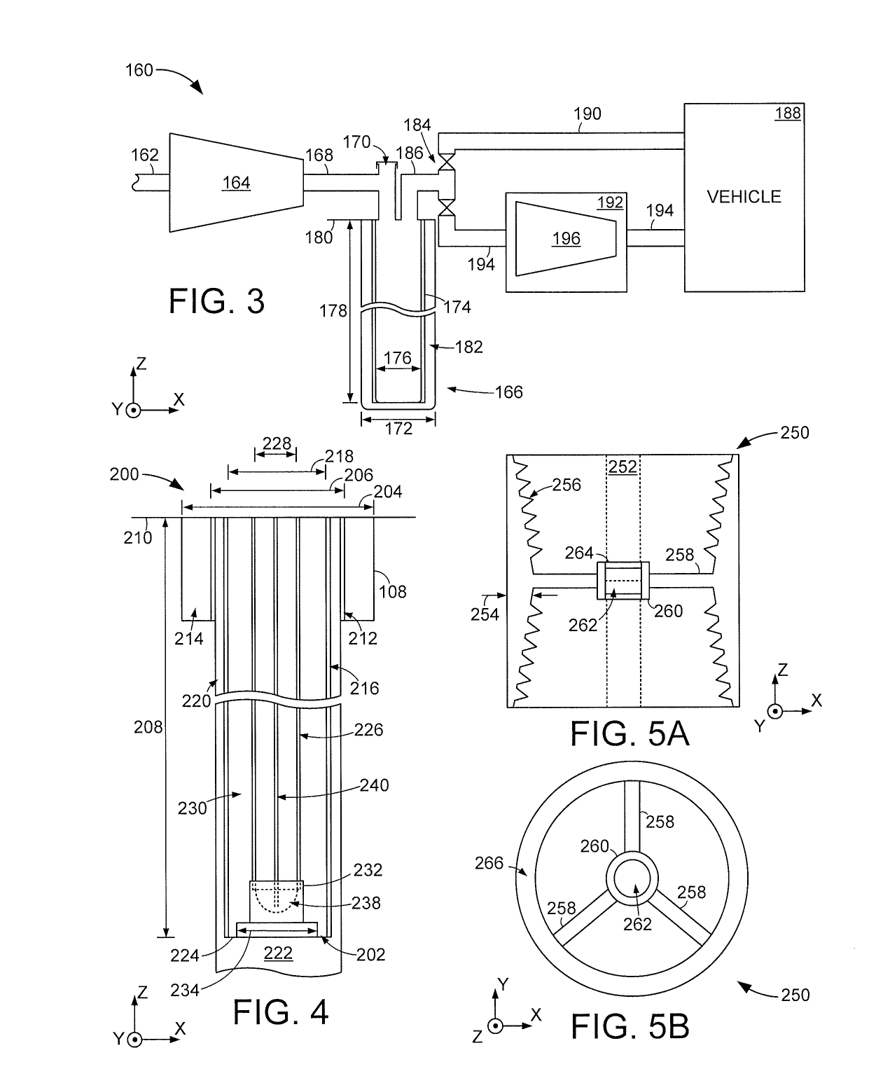

FIG. 3 displays a line representation of a portion of an example subterranean sealed bore fuel system 160 configured in accordance with various embodiments. A service inlet 162, such as a utility line or outlet from a mobile tank, can feed fuel to one or more compressors 164 to elevate the pressure of the fuel to a predetermined pressure, such as 3,600 psi and 5,000 psi. It is contemplated that a compressor 164 may be configured to compress fuel continually, sporadically, or routinely to provide the predetermined pressure. In a non-limiting embodiment, multiple compressors 164 are configured with different pressures and an outlet of a first compressor 164 being fed directly into an inlet of a second compressor 164, which may be positioned in an upstream stage of the second compressor 164.

The ability to tune the size and function of one or more compressors 164 allows the fuel system 160 to optimize the delivery of compressed fuel to a subterranean sealed bore 166. A non-limiting example is a compressor 164 can be tuned to be minimal power, such as 100-150 hp, and run continuously to deliver the predetermined pressure or tuned to have increased power, such as 250-400 hp, to deliver the predetermined pressure while operating less frequently that the reduce power compressor. The ability to tune the cost of the compressor 164 relative to the speed in which the compressor 164 can deliver a predetermined fuel volume at the predetermined pressure illustrates how the fuel system 160 can provide increased business efficiency and fuel delivery performance.

The compressor 164 can access the subterranean sealed bore 166 via a high pressure pipe 168 that may or may not include a vent 170 that ensures pressure of the sealed bore 166 is maintained below a predetermined pressure, such as 6,000 psi. It is contemplated that the high pressure pipe 168 and vent 170 enter the sealed bore 166 through separate apertures, but some embodiments conserve space by venting the high pressure pipe 168, as shown. The compressed fuel entering the subterranean sealed bore 166 can occupy less than the entirety of the bore width 172 and be contained within a sealed casing string 174, which may be a single string of P110 casing that has an inner width 176 that is less than the bore width 172. The combination of the casing string width 176 and the depth 178 below ground 180 provides the volume of the sealed bore 166 in which CNG and LNG fuel can be stored.

The storage of compressed gas in the ground can be difficult due to porous geological formations that can degrade bore pressure. In the past, subterranean reservoirs have stored natural gas for a variety of purposes, such as for reinjection and mass storage. However, such reservoirs are not conducive to high pressure fuel storage as the reservoir is at risk for inadvertent fracture, pressure loss, and gas loss. Also, gas stored in underground reservoirs may seep into water tables and caves to pose an environmental and safety hazard.

With the utilization of oil exploration techniques and structure, fuel can be safely and reliably compressed without concern for environmental and safety hazards due to the casing string 174 providing a high safety factor. Safety may further be increased by monitoring the bore 182 around the casing string 174 for increase in pressure and the presence of fuel, which can indicate a leak in the casing string. The ability to remove and install the casing string 174 at will without altering the bore 182 also provides safety and allows for changes to be made to the subterranean sealed bore, such as changing casing string 174 thickness and increasing bore depth 178. In some embodiments, a secondary string of pipe, casing, and/or resin can be inserted into the bore 182 to seal leaks that occur after installation.

It is acknowledged that the bore depth 178 could be nearly any distance from the surface 180, but various embodiments arrange the depth 178 to be greater than 440 feet and less than 10,000 feet below ground. It is contemplated that the bore 182 can be configured with a horizontal component along the X axis. Yet, assorted embodiments tune the bore depth 178 to be a function of cost versus storage capacity. That is, the depth 178 can factor in the size and cost of the drilling rig that is needed to install and remove the casing string 174, the thickness and weight of the casing string sidewall, and the casing width 176 to determine an optimized depth that balances cost of installation and service with storage volume. The bore depth 178 may further consider the number of subterranean sealed bores 166 that are to be utilized in a fuel system to relate bore depth 178 with overall fuel system storage capacity.

Upon selection by a valve assembly 184, which may consist of a plurality of similar or dissimilar types of valves, gas may exit the subterranean sealed bore 166 and be delivered to a vehicle 188 by a direct fill line 190. The direct fill line 190 can be characterized as delivery of fuel to the vehicle 188 at the pressure resident in the subterranean sealed bore 166. Fueling the vehicle 188 with the direct fill line 190 can be efficient and preferred for vehicles 188 with large fuel needs, such as industrial and long-haul trucks. While the direct fill line 190 can deliver relatively large volumes of fuel at the high pressure of the subterranean sealed bore 166, such fueling can quickly lower the pressure of fuel stored in the casing string 174.

The compressor 164 may be capable of overcoming pressure drop related to direct fueling to maintain a predetermined pressure in the casing string 174, but operation of the compressor 164 may not be efficient from a cost or time perspective. That is, operating the compressor 164 at some times of the day can correspond with elevated inlet fuel prices and decreased compressor 164 efficiency due to environmental factors, like temperature and humidity. Also, sporadically operating the compressor 164 in response to direct fueling can more quickly degrade compressor 164 performance, which can increase compressor 164 maintenance costs and service downtime compared to compressor 164 operation over an extended duty cycle, such as eight to twelve hours.

In the non-limiting embodiment shown in FIG. 3, the direct fueling capability provided by the direct fill line 190 can be selectively activated and deactivated in relation to fueling via the filling dispenser 192 and dispensing line 194. As shown, the dispensing line 194 can independently and concurrently deliver fuel with the direct fill line 190 according to selection of the valve assembly 184. The dispensing line 194 may pass through one or more downstream compressors 196 that may or may not be resident within the filling dispenser 192. In other words, at least one downstream compressor can be positioned anywhere between the valve assembly 184 and the vehicle 188, such as in the filling dispenser 192.

The downstream compressor 196 can be tuned, in some embodiments, to have smaller or larger power compared to upstream compressor 162, such as 150 hp or 300 hp. The ability to tune the downstream compressor 196 for size can provide fuel to the vehicle 188 at a higher pressure than the subterranean sealed bore 166 efficiently in the case of the compressor 196 having smaller power and quickly in the case of the compressor 196 having a larger power. The power of the downstream compressor 196 can be tuned in relation to the actual or predicted frequency of vehicle fueling instances and amount of fuel delivered to ensure fuel can be delivered to a vehicle 188 at a predetermined pressure, such as 3600 psi, regardless of the number of vehicles 188 and gge delivered recently.

It is noted that the direct fill line 190 and dispensing line 194 are shown as separate connections to the vehicle 188, but such a configuration is not required or limiting as the filling dispenser 192 may provide a single connection to the vehicle 188 that can selectively access the direct fill line 190 and/or the downstream compressor 196. The ability to intelligently coordinate the upstream compressor 162, direct fill line 190, and downstream compressor 196 can allow for increased numbers of direct fueling instances, faster fueling times, and minimal system 160 recharge time. That is, the system 160 can predict and recognize fueling trends and demand statically and dynamically to intelligently select to deliver fuel to the vehicle 188 via the direct fill line 190 or the dispensing line 194. It is noted that the filling dispenser 192 can be adapted to fill vehicles with multiple different filling means that accommodate different vehicle 188 fuel systems, such as adsorption based systems where fuel is dispensed at approximately 800 psi.

With the transmission and compression of fuel, liquids and debris can accumulate in a sealed tank. In above ground sealed tanks, gravity, internal pressure, and a drain orifice can efficiently evacuate contaminates like liquid and debris. However, the subterranean sealed bore 166 presents a different environment where gravity and a drain orifice are not easily employed. FIG. 4 displays example portions of a subterranean sealed bore 200 that can be incorporated into a fuel system in accordance with various embodiments. The subterranean sealed bore 200 can comprise a drilling bore 202 having at least first 204 and second 206 bore widths that continuously extend to some or all of a bore depth 208 into one or more geological formations below a ground surface 210.

As illustrated, the first bore width 204 may be positioned proximal the ground surface 210 and terminate before the full bore depth 208. A continuous surface casing string 212 can extend from the ground surface 210 to a predetermined depth, such as 500 feet, and be secured in place by a packing material 214, such as concrete, drilling mud, and cement. The combination of the surface casing string 212 thickness, as measured along the X axis, and packing material 214 can protect external subterranean geological formations, such as a water table, from the interior of the drilling bore 202.

Additional protection may be provided by a production casing string 216 that continuously extends to the bore depth 208 with a reduced width 218 and is secured by a second packing material 220 that may be similar or dissimilar from the packing material 214 separating the surface casing string 212 from subterranean rock and dirt. In a non-limiting embodiment, a single string of casing 216 has a 13⅜″ diameter with a 4″ encasement instead of using the surface casing string 212. The ability to configure the bore 202 with a variety of casings and encasements allows the bore 200 to maintain a minimum safety factor, such as 2, despite holding gas at 5000 psi or more.

Assorted embodiments utilize the second packing material 220 to seal the drilling bore 202 at the bore depth 208 with at least a pad 222. It is contemplated that the pad 222 may comprise a lamination of materials, such as a cement cap, and provide a substantially planar surface 224. It is contemplated that the production string 216 may be pressurized to several thousands of pounds per square inch to store fuel. However, a storage casing string 226 may be additionally installed in the sealed drilling bore 202 and provide a storage width 228 that is less than the bore widths 204 and 206 and casing width 218. Although not required, the storage casing string 226 can be fixed in place and any number of smaller strings of tube and/or casing can be inserted into the casing string 226 at will, such as to repair leaks.

The ability to tune the wall thickness, casing schedule, of the storage casing string 226 can allow high pressure fuel storage, such as 5,000 psi or more, while providing high safety factors. That is, the material of the storage casing string 226, such as 13⅝″ or more diameter casing, can withstand a maximum pressure well over 5,000 psi, which provides a safety factor over 1. Additionally, the production casing string 216 can have a material strength that can safely store fuel at more than 5,000 psi. Hence, the combination of the tuned thickness and material strengths of the storage 226 and production 216 casing strings provides redundant factors of safety that can ensure that fuel stored in the subterranean bore 202 is safely contained, even if a leak in the storage casing string 226 occurs.

In various embodiments, one or more stabilizing features, such as a bushing and packer, can be positioned in the open gap 230 between the storage casing string 226 and the production casing string 216 to secure the storage casing string 226 in place. Although stabilizing features can be employed, it is contemplated that the end of the storage casing string 226 can be susceptible to trauma and potential leaks during installation and pressurization. Possible contributors to trauma and leaks is the planar surface 224 of the pad 222 forcing the string end one side of the production casing string 216 and impact between the storage 226 and production 216 casing strings. Although a plate or cap may be welded onto the end of the storage casing string 226, such measures may not be sufficient to minimize trauma and prevent leaks.

Accordingly, a shoe 232 may be affixed to the end of the storage casing string 226 and provide a wider width 234 than the storage width 228. The size, material, and width 234 of the shoe 232 can be individually and collectively tuned to minimize impact during storage casing string 226 installations and centralize the string 226 within the production casing string 216 at the bore depth 208. In other words, the shoe 232 can be tuned to position the storage casing string 226 substantially in the center of the production casing string 216 despite the planar surface 222 being angled, non-uniform, or incomplete with respect to the X axis. Such storage casing string 226 centralization can be provided, in some embodiments, by the shoe flange 236 that extends to the wider width 234 and is tuned to allow efficient installation and stabilization without damaging the production casing string 216.

The shoe 232 may be further tuned to provide a collection region 238 positioned within the shoe 232 and downhole from the end of the storage casing string 226. The collection region 238 may have continuously curvilinear and linear surfaces that aid in the accumulation of liquids and debris in a predetermined portion of the shoe 232. For example, the collection region 238 may have symmetrical and asymmetrical portions that funnel liquids and debris to aid in the removal thereof. While the storage casing string 226 can be removed and drained in various embodiments with the installation of a drain orifice in the shoe 232, such activity is costly in terms of operation downtime and equipment expense to pull the storage casing string 226 out of the drilling bore 202.

With these issues in mind, a service vent 240 can be configured to continuously extend from the ground surface 210 to the collection region 238 to allow for suction or pressure to remove any liquid and debris present in the storage casing string 226. It is contemplated that a continuous, seamless run of tubing, such as coiled tithing) can he temporarily or permanently installed downhole to provide a pressure differential inside the casing string 226 that allows liquids and debris to be efficiently removed from the casing string 226. With a temporarily installed service vent 240, liquids and debris can be removed from the storage casing string 226 before the service vent 240 is removed from the casing string 226, which provides increased volume for fuel storage.

However, continuous tubing can be difficult to reliably install and remove at some depths, such as over 1000 feet, due to the tubing loosely bouncing off the internal sidewalls of the storage casing string 226, which can damage the tubing and may result in increased amounts of debris. Hence, various embodiments configure the service vent 240 to rigidly extend through a predetermined portion of the storage casing string 226, such as substantially the center of the string 226. In some embodiments, the service vent 240 is configured as rugged tubing, such as 2″ or more diameter material with a sidewall thickness of 0.167-0.254,″ which can reliably endure installation into the casing string 226, high pressure fuel storage, and debris evacuation at the expense of slightly less fuel storage volume inside the casing string 226. Alternatively, it is contemplated that the service vent 240 can continuously extend outside the storage casing string 226 and remove liquids and debris from the storage casing string 226 via one or more apertures, such as a valve, diaphragm, or hole in the shoe 232.

FIGS. 5A and 5B respectively illustrate cross-section and top views of an example storage casing coupling 250 that can be utilized in a subterranean sealed bore in accordance with some embodiments to secure a service vent 252 in a predetermined position within a storage casing string. The coupling 250 can be configured with a uniform or varying sidewall thickness 254 that presents at least one thread 256 that can engage corresponding threads of a casing string to create an airtight seal. The coupling 250 can be configured with one or more rigid or flexible arms 258 that position and support at least one bracket 260 substantially in the center of the coupling 250 and corresponding storage casing string.

The bracket 260 can be constructed in a variety of different manners to secure the service vent 252, none of which are required or limiting. Various embodiments configure the bracket with an aperture 262 that continuously extends completely through the bracket 260 along the Z axis and with a width that allows the service vent 252 to be temporarily and permanently affixed within the aperture 262. It is contemplated that the service vent 252 comprises multiple pieces interconnected via a sealing feature. As shown in FIG. 5A, O-ring 764 sealing features can be positioned between the service vent 252 and bracket 260 to ensure an airtight fitting capable of maintaining integrity over a range of positive and negative pressures, such as −1000 psi suction and 1000 psi pressure.

FIG. 5B conveys how the storage casing coupling 250 can be tuned with multiple securing arms 258 that extend from the coupling sidewall 266 to position the bracket 260 in a center of the coupling 250 in the Y-X plane. As illustrated, the securing arms 258 are placed equidistant about the bracket 260, but such configuration is not required as non-radially symmetrical arm 258 configurations may be employed without limitation. It should be noted that the size, shape, material, and number of securing arms 258 may be tuned individually and collectively to minimize the volume displacement of the service vent 252 securing assembly. That is, the arms 258 and bracket 260 can be configured to be as small as possible to displace a minimal amount of volume inside the storage casing string, which corresponds with more fuel being stored in the storage casing string.

The ability to tune the position and securement of the service vent 252 within the coupling 250 as part of a storage casing string allows the service vent 252 to efficiently remove liquids and debris from the storage casing string. For example, a central location of the service vent 252 within the storage casing string can complement a shaped collection region, such as region 238 of FIG. 4, to provide laminar flow that allows liquids and debris to be suctioned through the vent 252 or blown up to the ground level. Conversely, positioning the service vent 252 proximal a side of the storage casing string may require more time and pressure to evacuate liquids and debris as turbulent flow can impede the movement of materials to the ground level. In the event the coupling 250 is not used, pressures can be equalized on both sides of the service vent 252 to reduce and eliminate service vent 252 movement during operation.

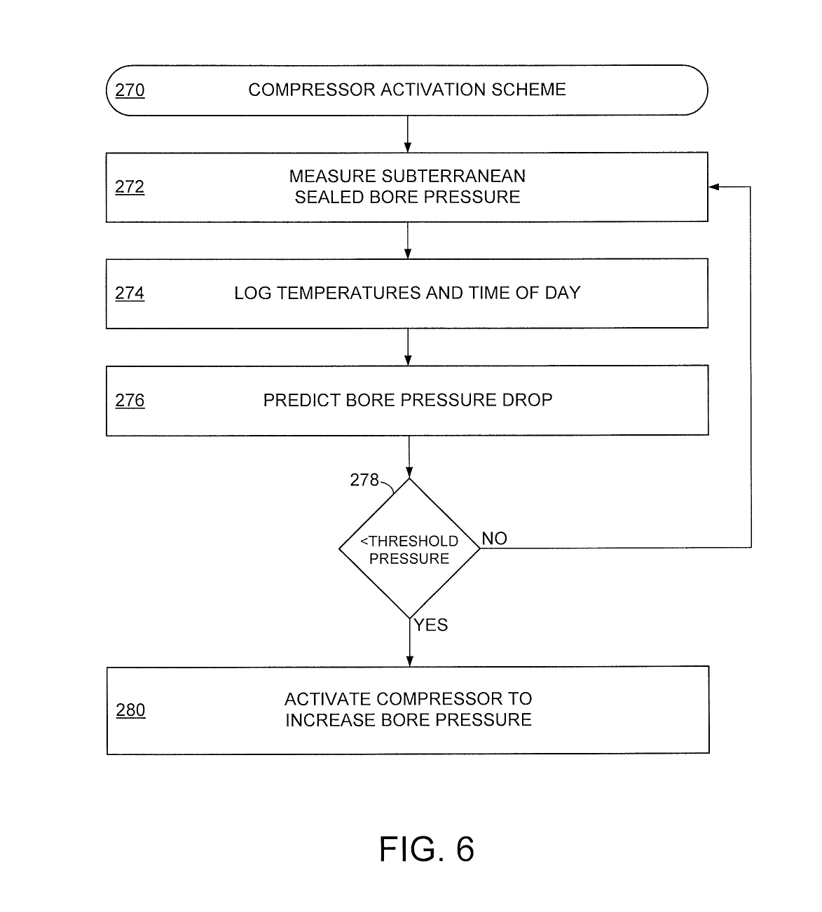

FIG. 6 is an example compressor activation scheme 270 that may be carried out with one or more subterranean sealed bores as part of a fuel system in accordance with assorted embodiments. The compressor activation scheme 270 may be conducted locally, such as by an upstream or downstream compressor, remotely, such as by a host connected via a network, and in conjunction with combinations of local and remote controllers. In the non-limiting example shown in FIG. 6, pressure measurements are taken by sensors of the subterranean sealed bore in step 272. Such measurements may he dictated, logged, and computed by one or more local and remote components that can coordinate the sensed static or dynamic pressure with environmental measurements taken and logged in step 274.

Various embodiments utilize step 274 to measure the air and ground temperatures about a subterranean sealed bore as well as the time of day in which the measurements are taken. The sensed sealed bore pressure and environmental temperatures can be used in combination with logged and generated fuel delivery profiles to predict sealed bore pressure drop in step 276. A fuel delivery profile may consist of an actual or predicted model of fuel demand over a given period of time, such as a day. The fuel delivery profile can increase the accuracy of the predicted sealed bore pressure drop in step 276.

Next, decision 278 evaluates if the predicted sealed bore pressure drop brings the bore pressure below a predetermined threshold, such as 3,600 psi. Decision 278 may further evaluate if the current sealed bore pressure is below the predetermined threshold. In the event the threshold pressure is, or is predicted to, drop below the predetermined threshold, step 280 schedules at least one compressor to activate to increase pressure of the sealed bore. For instance, step 280 could immediately activate an upstream compressor or delay activation until a more conducive timeframe, such as a delay of 10 minutes or 1 hour. If the threshold pressure is not threatened currently and in the predicted future, scheme 270 may revisit step 272 for continuous, sporadic, and routine measurement of sealed bore pressure.

The ability to selectively activate a compressor with scheme 270 allows for optimized fuel system performance as fuel is more efficiently brought to a higher pressure. In contrast, a compressor that operates continually or over a duty cycle regardless of sealed bore pressure is inefficient by wasting energy and shortening compressor lifespan. It is contemplated that a compressor may be activated selectively in response to the sealed bore falling below the predetermined threshold, but such reactive activation may not be sufficient to deliver large volumes of fuel to vehicles in a timely manner. Thus, the utilization of a fueling profile allows for the prediction of sealed bore pressure and proactive activation of a compressor to ensure ample volumes of fuel can be delivered without a noticeable increase in fueling time for a consumer.

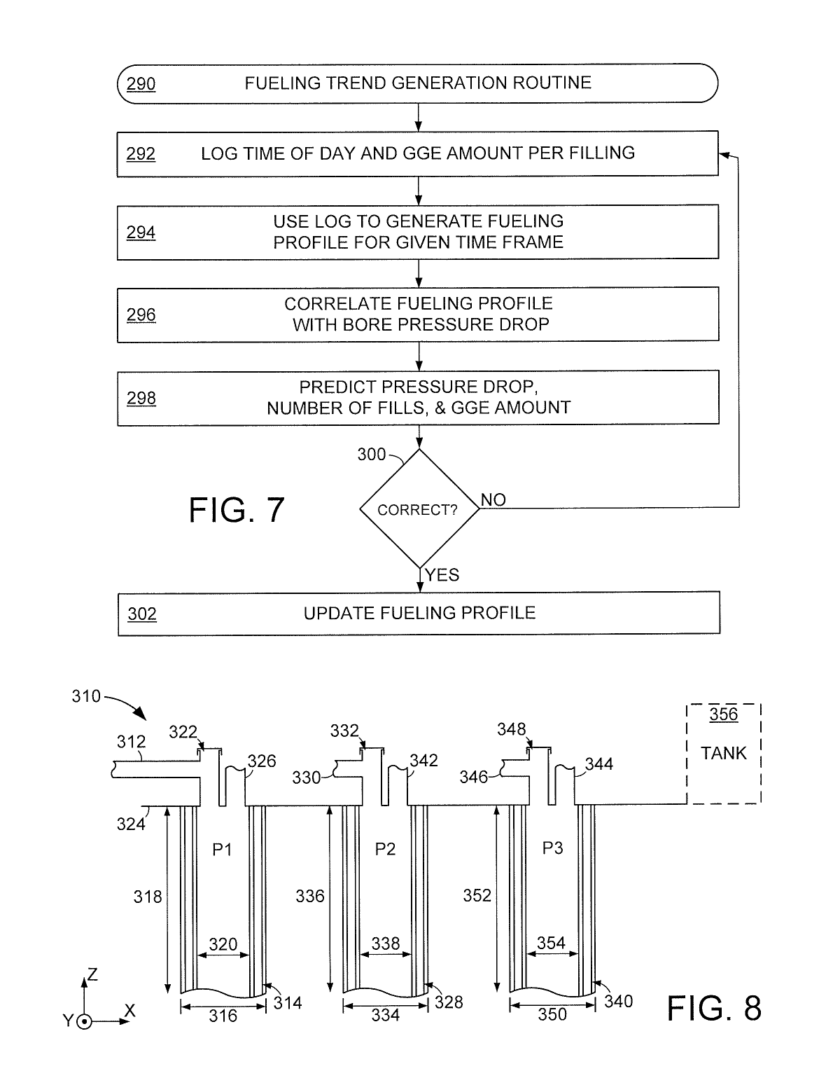

Although a fueling profile may be stored, learned, and modified based on an unlimited variety of measured and computed parameters, some embodiments build a fueling profile for a given time frame based on the fueling trend generation routine 290 displayed in FIG. 7. It is contemplated that a sample or baseline fueling profile may provide the basis for a generated fueling trend. Such sample fueling profile may compile historic data relating to the sale of gasoline or propane. Regardless of whether routine 290 begins with a sample fueling profile, step 292 operates over time to measure and log at least the time of day, fueling time, and gge amount of fuel delivered per filling. It is understood that step 292 may log multiple different fillings concurrently.

Over time, the logged fueling data from step 292 can be used in step 294 to generate a fueling profile for a given time frame, such as a 24 hour day. As a non-limiting example, a fuel profile generated in step 294 may utilize statistical analysis, such as averages and standard deviation, to model consumer demand for fuel over a day, week, and month. The fuel profile of step 294 can then be correlated with measured sealed bore pressure drop to determine how the fuel system is reacting to consumer fuel demand. The correlation of sealed bore pressure to the fueling profile can produce a fueling trend in step 298 that predicts at least sealed bore pressure drop, number of fueling instances, and amount of fuel delivered in the future.

The generation of the fueling trend in step 298 may be incorrect, if that is the case, decision 300 evaluates the accuracy of the trend by comparing predicted fueling behavior with actual fueling behavior. Actual fueling instances that are within a predetermined tolerance of the fueling trend can be used in step 302 to update the fueling profile and fueling trend to further increase accuracy. However, in the event the fueling trend is not deemed accurate in decision 300, step 292 can be revisited and may correspond with portions of existing fueling data being removed from the fueling trend generation algorithm. With the capability of recognizing that a fueling trend is incorrect and removing existing data, exceptional fueling behaviors can be purged from the fueling trend and fueling profile and a more precise prediction of consumer behavior can be achieved.

It is noted that various embodiments of a subterranean sealed bore fuel system have fuel supplied via a utility line, such as line 162 of FIG. 3. Yet, a utility line is not required as a mobile fuel tanker may supply a subterranean sealed bore and a fuel system. For instance, a fuel tanker can supply pressure directly to a subterranean sealed bore at a pressure that is increased by a downstream compressor before and during consumer demand for fuel. The ability to supply CNG and LNG directly to a subterranean sealed bore can allow efficient installation of natural gas fueling stations and delivery points where natural gas utility lines are not prevalent, such as rural areas and regions of the country that use fuel oil instead of natural gas for fuel.

As an example, a filing station that historically provides gasoline and has no direct access to a natural gas utility line can install a subterranean sealed bore fuel system and provide CNG fuel exclusively and in combination with gasoline. In such an example, mobile CNG tanker trucks would service the subterranean sealed bore much like a gasoline tanker truck services underground gasoline tanks. The ability to store large volumes of CNG and LNG can also have industrial applications for consumers installing and retrofitting equipment powered by compressed gas. As a non-limiting instance, chicken and pig farmers that utilize propane to heat animal structures can retrofit turnkey install a subterranean sealed bore that supplies the heating equipment with natural gas fuel at a reduced price due to the cost of natural gas being historically lower than other liquefied gases like propane and butane.

Another example of a subterranean sealed bore fuel system application is providing reserve fuel for a home or business, such as a medical facility, that can be used in the event of a catastrophe, power outage, and high utility delivery prices. As such, a consumer may store CNG in a residential subterranean sealed bore and utilize the stored fuel instead of drawing gas from a utility line at peak price delivery times, which may reduce the consumer's fuel costs and provide emergency heat and electricity in combination with a generator. The ability to provide 500-750 gge or more of CNG in a single subterranean sealed bore, an array of multiple subterranean sealed bores can provide mass CNG storage for industrial purposes, such as for gas providing companies, to mitigate costs associated with buying fuel at peak pricing times.

FIG. 8 illustrates a line representation of a portion of an example subterranean sealed bore fuel system 310 configured in accordance with various embodiments to employ multiple subterranean sealed bores. The fuel system 310 is delivered fuel at an initial pressure, such as 2-5 psi by a utility line or 3,000-3,600 psi by a tanker truck, which may or may not be compressed by an upstream compressor before flowing through an array inlet pipe 312 and into a first subterranean sealed bore 314. The first subterranean sealed bore 314 can be constructed with a first bore width 316, such as 12 inches, a first bore depth 318, such as 1,500 feet, and a first storage casing width 320, such as 7 inches. The first subterranean sealed bore 314 can be maintained below a selected first pressure (P1), such as 5,000 psi, by a safety valve 322 that may be positioned above or below ground level 324.

Upon selection, fuel stored in the first subterranean sealed bore 314 is supplied to a hub via a first outlet pipe 326. The hub may be a valve assembly, control board, downstream compressor, or filling dispenser that can test, direct, and deliver fuel to a user, such as vehicle or heater. The fuel system 310 may be configured to cascade the first subterranean sealed bore 316 with a second subterranean sealed bore 328 via a second array inlet pipe 330 that is maintained at a lower second pressure (P2), such as 4,500 psi, by a safety valve 332. The lower second pressure can correspond with dissimilar or dissimilar bore dimensions compared to the first subterranean sealed bore 314. In other words, the second subterranean sealed bore 328 may be constructed with a second bore width 334, second bore depth 336, and second storage casing width 338 that can independently and collectively be different than the first width 318, depth 318, and casing width 320 of the first subterranean sealed bore.

The ability to maintain a lower pressure in the second subterranean sealed bore 328 allows for efficient transfer of fuel from the first subterranean sealed bore 314 without an intervening compressor. Also, a lower second pressure allows an upstream compressor to pressurize only the first subterranean sealed bore 314, which can subsequently fill the second 328 and third 340 subterranean bores via a hub. In other words, the hub can control and deliver fuel between the subterranean sealed bores 314, 328, and 340 via the respective outlet pipes 326, 342, and 344 as well as the respective inlet pipes 312, 330, and 346.

Various embodiments may tune the various subterranean sealed bores to have common dimensions, which allow the pressures of the sealed bores P1, P2, and P3 to be changed with a modification to the respective safety valves 322, 332, and 348. For example, the third subterranean sealed bore 340 may have a bore width 350, depth 352, and casing width 354 that substantially matches the respective dimensions of the second subterranean sealed bore 328, but differ from the first subterranean sealed bore. Such tuned dimensions of the sealed bores 314, 328, and 340 can optimize installation cost and fuel delivery efficiency as larger volumes of higher pressure fuel can be kept in reserve as smaller volumes of lower pressure fuel are more often tapped by consumer fuel demands.

It is contemplated that one or more above ground sealed tanks 356 can be utilized in combination with the plurality of subterranean sealed bores. An above ground tank 356 may provide buffer storage that can allow for fast consumer fueling conditions as well as fast fuel transfers between sealed bores. It is noted that the various pressures of the fuel system 310 are not limited to a particular range or difference. In some embodiments, multiple subterranean sealed bores can be utilized to store different types of fuel.

FIG. 9 is a line representation of a portion of an example subterranean sealed bore fuel system 360 configured to provide LNG and CNG from at least first 362 and second 364 subterranean sealed bores. As shown, the first subterranean sealed bore 362 can have a bore width 366, depth 368, and storage width 370 that is configured to receive LNG from an inlet pipe 372 and maintain the fuel in a liquid state. At least one refrigeration assembly 374, such as a cryogenic chiller, can selectively cool the first subterranean bore 362 via a valve assembly 376.

The valve assembly 376 may further direct LNG directly to a filling station 378 to allow liquid fuel to be delivered to a consumer via a liquid line 380. It is contemplated that the below ground storage of LNG is more efficient than above ground storage due to the reduced volatility of temperatures and humidity underground. However, some embodiments configure the first subterranean bore 362 with a partial or continuous insulating material, such as a polymer or rubber coating, which acts as a blanket and increases the efficiency of the refrigeration assembly.

A second subterranean sealed bore 382 may be configured to store LNG, which may be serviced by refrigeration assembly 374 or by a different temperature controlling means. Embodiments where the second subterranean sealed bore 382 is configured to store CNG may have one or more expansion chambers 384 that have greater widths 386, along the X axis, than the storage casing width 388. As such, LNG entering the second subterranean sealed bore 382 can expand and transition into CNG, which may occur at around 650 psi. It is contemplated that compressing means can selectively be activated and deactivated to allow the LNG to transition into CNG and then pressurize the second subterranean bore 382 to a pressure that can be delivered to a vehicle via a direct line 388 or to the filling dispenser 378. Alternatively, the CNG can be stored at a low pressure, such as 650 psi, in the second subterranean bore 382 and a downstream compressor can increase the pressure of the CNG upon consumer demand.

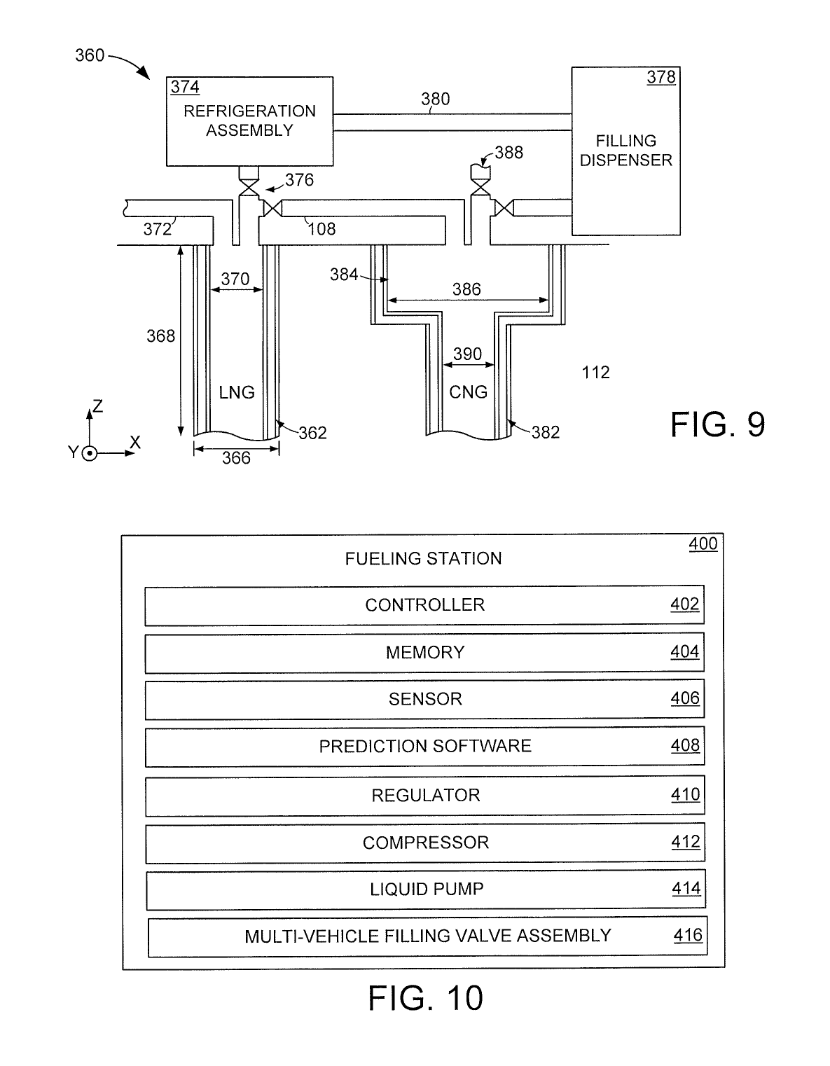

FIG. 10 is a block representation of an example fueling station 400 that can be utilized by a subterranean sealed bore fuel system in accordance with assorted embodiments. The fueling station can have at least a local control circuit 402 that acts as a controller to direct fueling conditions and execute software stored in local memory 404. The local controller 402 may further conduct various activities as dictated by a remote host, which may involve activating various sensors 406 to and logging data that can he computed locally by prediction software 408 that identifies fueling trends and generates fueling profiles, such as by routine 290 of FIG. 7.

The fueling station 400 may utilize local and remote computing means to control the manner in which fuel is delivered to a consumer to ensure ample fueling capacity over the course of a day, week, and month. That is, the fueling station 400 can reactively and proactively modify the pressure at which fuel is delivered to a consumer to conserve subterranean sealed bore pressure. For instance, the fueling station 400 can pass fuel through a regulator 410 that reduces the pressure of the fuel and increases fueling time for the consumer, but lessens the stress on compressors of the fuel system to operate at non-ideal times to replenish the sealed bore pressure. The fueling station 400 may also lessen stress on a fuel system compressor by activating a local compressor 412 in the case of CNG delivery, or a liquid pump 414 in the case of LNG delivery, to increase fuel delivery pressure without unduly depressurizing a subterranean sealed bore.

It is contemplated that the fueling station 400 can react to changing fueling conditions. For example, the fueling station 400 may be direct filing a consumer when an additional vehicle concurrently demands fuel, which triggers the fueling station 400 to activate a multi-vehicle filling valve assembly 416 and a local compressor 412 while switching the first consumer from a direct fill line to a downstream compressed line. The ability to learn fueling trends and adapt to changing fueling conditions allows the fueling station 400 to service a large number of consumers and volume of fuel, maintain a high sealed bore pressure, and keep a low cost compressor operating schedule, such as during off-peak pricing hours. In assorted embodiments, a power fill system is utilized to provide an increased volume of the gas in a bore at lower pressures, such as 1200 psi.

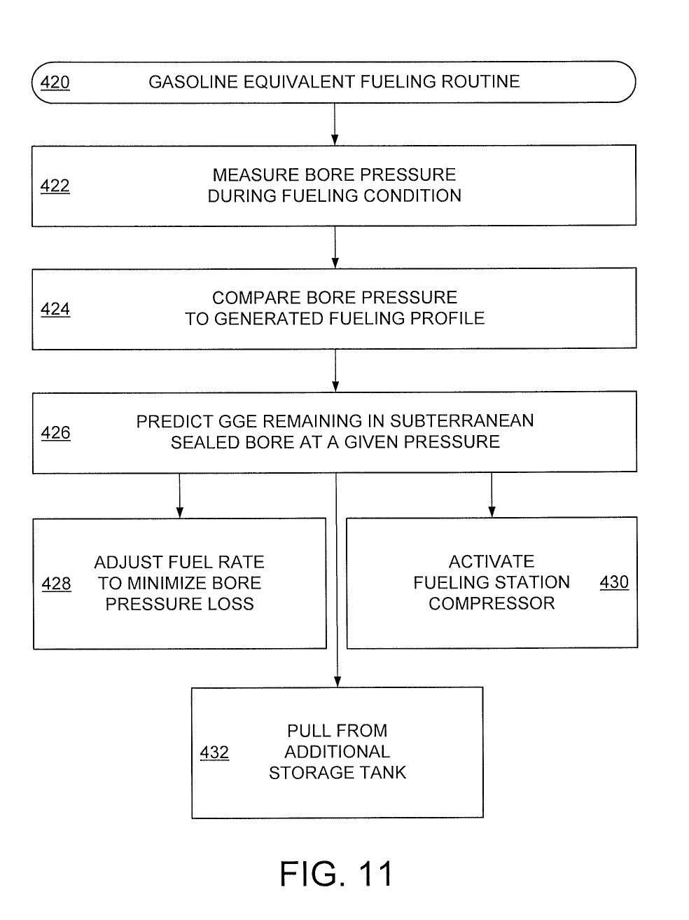

FIG. 11 is a flowchart of an example gasoline equivalent fueling routine 420 that may be conducted by a subterranean sealed bore fuel system in accordance with some embodiments. Initially, step 422 measures sealed bore pressure during at least one fueling condition where fuel is flowing to a consumer. Step 422 is conducted during a fueling condition to accurately identify a pressure differential between the consumer and the sealed bore, which can be used in comparison to a generated fueling profile in step 424 to predict the amount of gge remaining in the subterranean sealed bore in step 426 at a given pressure, such as 3,600 psi. For clarification, step 422 measures sealed bore pressure, step 424 uses the measured data to evaluate if a fueling profile for a given time can be utilized, and step 426 uses the bore pressure from step 422 alone or in combination with a fueling profile to predict the volume of fuel available at a given pressure.

The identification of the volume of fuel at a given pressure can allow a fueling station to take a variety of reactive and proactive actions to ensure consumer demand for fuel can be serviced timely. It is noted that fueling may occur while a compressor creating a pressure differential between the consumer and the sealed bore, but such condition is slow and inefficient. Hence, it is the goal of routine 420 to provide immediate pressure differential regardless of the number of consumers demanding fuel and the amount of fuel being delivered. Accordingly, a fueling station can adjust the fuel delivery rate in step 428 to minimize bore pressure loss, which may allow an upstream compressor to pressurize the sealed bore faster than the fuel is being delivered or allow fuel to cascade through multiple subterranean sealed bores.

The fueling station may activate a fueling station compressor to supplement the pressure from the subterranean sealed bore in step 430 without causing a noticeable consumer delay in fuel time. Step 432 may also be conducted by a fueling station to pull fuel from one or more additional storage tanks, such as above ground buffer tanks. It is noted that steps 428, 430, and 432 may be conducted concurrently and individually. It is further noted that a fueling station may recognize a changing condition or a unique fueling condition and disregard the fueling profile to adapt to the condition by cycling through steps 428, 430, and 432 at will. The ability for the fueling station to take a variety of measures to preserve sealed bore pressure provides optimized fuel system performance that can meet diverse consumer demand with intelligent actions, as opposed to a set list of actions that may not be appropriate for a fueling condition.

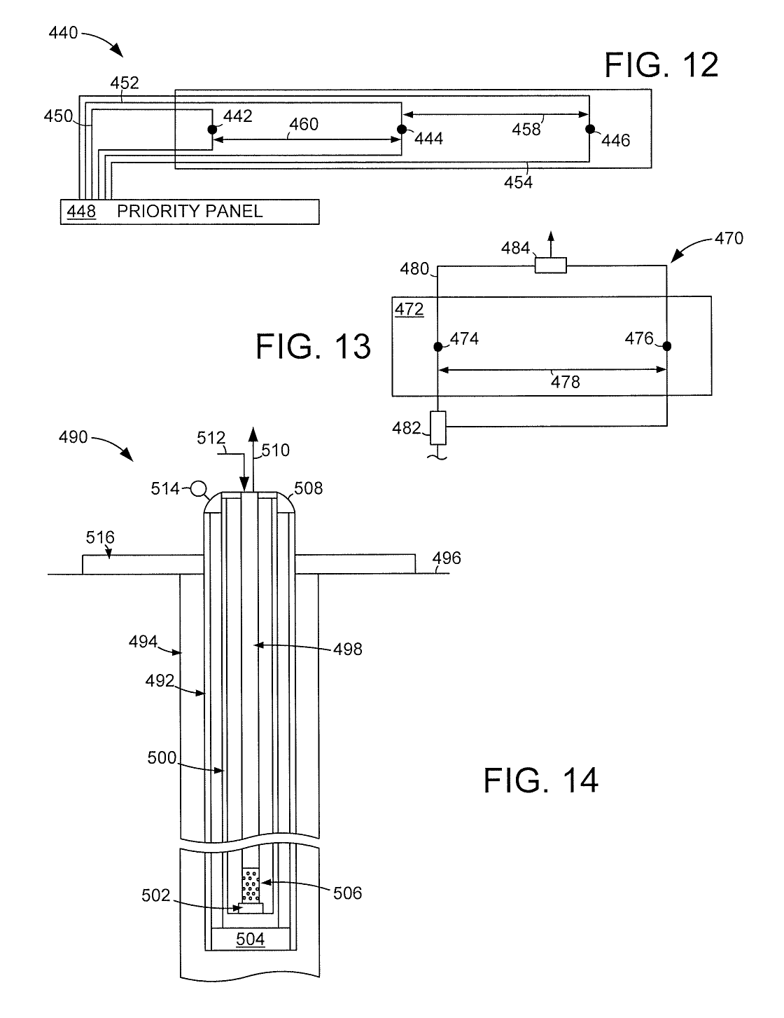

FIG. 12 illustrates a portion of an example subterranean fuel system 440 arranged in accordance with various embodiments to provide first 442, second 444, and third 446 vents connected to a priority panel 448 that houses one or more control circuits. The control circuits can cascade CNG from one subterranean sealed bore to another through first 450, second, 452, and third 454 fill and discharge lines, which respectively may be tubing and/or piping. The various vents 442, 444, and 446 can be positioned on a common pad 456 with at least minimum separation distances 458 and 460 that may be the same, such as 15 feet, or different.

FIG. 13 is a line representation of a portion of an example subterranean fuel system 470 arranged in accordance with some embodiments. The fuel system 470 can have a common pad 472, such as a concrete or rock area, in which first 474 and second 476 subterranean sealed bores are spaced apart by a minimum distance 478. The sealed bores 474 and 476 can be connected by transport lines 478 to at least one connection port 482, such as a tube truck connection box, as well as a meter 484 that measures the amount of CNG flowing downstream to a vehicle and/or fueling station.

Although it is contemplated that a fuel system can contain differently configured subterranean sealed bores, FIG. 14 shows a cross-sectional line representation of a portion of an example subterranean sealed bore 490. The sealed bore 490 is defined by a drilling bore 492 in the ground 494 and below ground level 496. A service vent 498 continuously extends within a casing 500 from above ground level 496 to first 502 and second 504 plates that individually and collectively serve as a shoe to stabilize the service vent 498 to the bottom of the drilling bore 492. A portion of the service vent 498 can be perforated to allow efficient flow to and from the service vent 498.

The casing 500 can be sealed above ground level 496 by a wellhead cap 508 that can connect the service vent 498 with a pressure relief outlet 510 and a fill inlet 512 that can be monitored by a pressure gauge 514. The portion of the sealed casing 500 can be buttressed by contacting rigid members 516, such as concrete, steel, or wood. In some embodiments, the pressure relief outlet 510 can be set to a particular threshold value, such as 5000 psi, and the wellhead cap 508 can be positioned at least a wellhead distance, such as 12 inches, that allows the rigid members 516 to support the casing 500 efficiently.

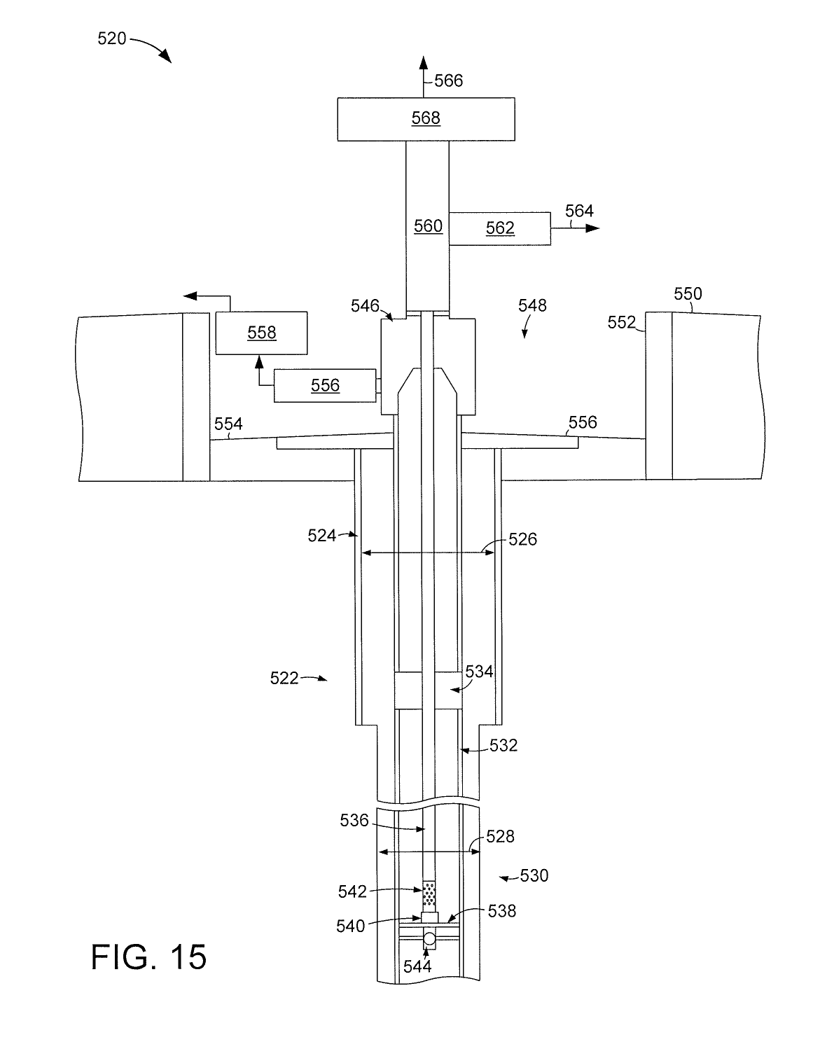

FIG. 15 depicts a cross-sectional line representation of a portion of an example subterranean sealed bore 520 configured in accordance with various embodiments. The sealed bore 520 consists of a single drilling bore 522 that has a first region 524 that has a wider width 526 proximal ground level compared to a second width 528 in a second region 530. A single continuous casing string 532 that has a predetermined diameter, such as 13.375 inches, consists of multiple casing pipes connected via a coupling 534. A service vent 536 continuously extends from a resin plug 538 and a termination collar 540 up through the casing 532.

The service vent 536 has a perforated region 542 that can be 2 feet or longer to allow CNG to flow into, and out of, the casing 532. The bottom of the drilling bore 522 can employ one or more check valves 544, such as a ball valve, which allows for the evacuation of gas and liquids from the sealed bore 520, if needed. At the opposite end of the casing 532, a wellhead cap 546 connects to the service vent 536 in a trench 548 positioned below ground level 550. The trench 548 can be exposed to open air or enclosed by tuning the size of trench sidewalls 552. With an open air configuration, the trench 548 can have first 554 and second 556 surfaces sloped to at least one gradient, such as 2% slope. It is contemplated that the first surface 554 is rock and the second surface 556 is concrete to facilitate ample drainage despite being below ground level 550. A first valve assembly 556 may also be positioned below ground level 550 to provide pressurized CNG to a priority panel 558 that directs flow of CNG to a customer.

A second valve assembly 560 can connect the sealed bore 522 to a first outlet valve 562 that controls passage of CNG to an outlet 564, such as a coalescing filter, a vehicle, or an appliance. A second outlet 566 from the wellhead cap 546 is controlled by a second outlet valve 568, which can be a relief valve that may consist of multiple individual valves and at least one relief stack. The use of the resin plug 538 with the multiple outlet valves 556, 562, and 568 can provide additional safety without degrading CNG flow rates. That is, the resin plug 538 can provides a solid base for the drilling bore 522 and the various valve assemblies concurrently allow for safety monitoring and intervention along with high CNG volume output.

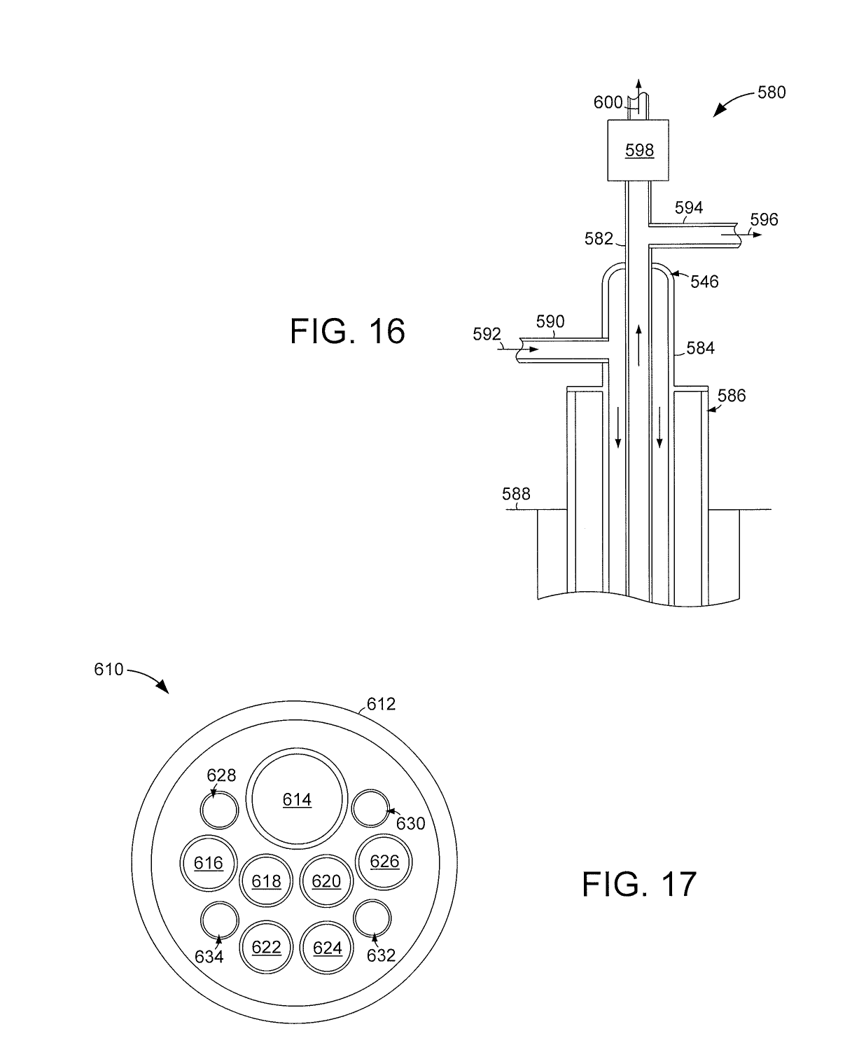

FIG. 16 displays a cross-sectional line representation of a portion of an example subterranean sealed bore 580 arranged in accordance with various embodiments to provide efficient fuel delivery and storage at a predetermined pressure, such as above 5000 psi. The sealed bore 580 can be occupied by a single service vent 582 suspended in a single casing string 584. A secondary casing 586 can provide additional separation of the casing string 584 and the ground 588, which adds a level of safety.

The sealed bore 580 has at least one fill inlet 590 that is selectively coupled to a compressor, priority panel, and or tube truck with an input 592. A discharge outlet 594 can provide a conduit for CNG to pass outwardly 596 towards a coalescing filter, vehicles, and/or appliance. A relief valve assembly 598 can selectively open to vent CNG to a relief stack 600. The ability to tune the number, size, and position of the various sealed bore inlets and outlets allows internal CNG pressure to be maintained while allowing high volume flow rates into and out of the casing string 584.

FIG. 16 is a cross-sectional line representation of a portion of a casing 610 that may be employed in a subterranean sealed bore in accordance with some embodiments. The casing 612 may have any number of tubes and/or pipes contained within casing pipe 612, such as P110 piping. A first internal conduit 614 can be vacant and used as a spare just as a smaller second conduit 616. Third 618, fourth 620, fifth 622, and sixth 624 conduits can each respectively house stainless steel tubing extending into the subterranean bore.

As shown, a seventh conduit 626 can be vacant and used as a spare while the eighth conduit 628 houses pressure transmitters. Electrical wire can be housed within ninth 630, tenth 632, and eleventh 634 conduits to provide electric static discharge and rectifier capabilities for a sealed bore fuel system. It is noted that the casing 612 can enclose any number of conduits with any size and purpose. Hence, the casing 612 can be tuned to safely isolate various electrical components from CNG carrying tubes, which minimizes the risk of inadvertent spark induced hazards.

Through the tuned installation and operation of a subterranean sealed bore, fuel system cost and efficiency can be optimized. Configuring a service vent in a storage casing of a sealed bore allows liquids and debris to be removed without removing the storage casing, which increases service efficiency. The fuel system can learn fueling trends and generate fueling profiles that allow proactive actions to be made to consistently deliver fuel at a given pressure and to maintain a low cost compressor activation schedule, which increases operating efficiency. Moreover, positioning natural gas compressed at thousands of pounds per square inch below ground provides increased levels of safety versus above ground storage tanks and allows of the capitalization of greater amounts of above ground surface area for business generation, which increases income generation efficiency.

What is claimed is:

1. A system comprising at least one subterranean sealed bore connected to at least one compressor and one or more control circuits to store natural gas at a predetermined pressure, each subterranean sealed bore comprising a casing string extending a predetermined depth below ground, the one or more control circuits comprising a log of activity in each subterranean sealed bore and a prediction model compiled in response to the log of activity.

2. The system of claim 1, wherein the casing string of a first subterranean sealed bore extends from a resin plug positioned downhole from a valve controlled by the one or more control circuits.

3. The system of claim 1, wherein the predetermined pressure is 6000 psi or more.

4. The system of claim 1, wherein the predetermined depth is more than 440 feet and less than 10,000 feet.

5. The system of claim 1, wherein an outlet of a first compressor is connected to an inlet of a second compressor.

6. The system of claim 1, wherein each subterranean sealed bore is connected to an above ground tank.

7. The system of claim 1, wherein a first subterranean sealed bore comprises a suspended internal pipe having a smaller diameter than the casing string.

8. The system of claim 7, wherein a portion of the suspended internal pipe is perforated.

9. A method comprising:
constructing at least one subterranean sealed bore comprising a casing string continuously extending a predetermined depth below ground;
connecting each subterranean sealed bore to at least one compressor and one or more control circuits to store natural gas at a predetermined pressure within the at least one subterranean sealed bore;
collect a log of activity in the at least one subterranean sealed bore with the one or more control circuits; and
compiling a prediction model in response to the log of activity.

10. The method of claim 9, wherein the log of activity comprises natural gas delivery times, pressures, and durations.

11. The method of claim 9, wherein the prediction model comprises a time and pressure drop corresponding to a future fueling demand by a fueling station.

12. The method of claim 9, wherein the one or more control circuits utilize the prediction model to minimize the operation of the at least one compressor during peak electricity rates.

13. The method of claim 9, wherein the prediction model computes how many vehicles can be filled by the at least one subterranean bore without activating the at least one compressor.

14. The method of claim 9, wherein the one or more control circuits redistribute natural gas between first and second subterranean sealed bores in response to the prediction model.

15. A method comprising:
constructing at least one subterranean sealed bore comprising a casing string continuously extending a predetermined depth below ground;
connecting each subterranean sealed bore to at least one compressor and one or more control circuits to store natural gas at a predetermined pressure within the at least one subterranean sealed bore;
collect a log of activity in the at least one subterranean sealed bore with the one or more control circuits;
compiling a prediction model in response to the log of activity;
activating the at least one compressor with the one or more control circuits to proactively increase the predetermined pressure to maintain a predetermined flow rate to a fueling station over time.

16. The method of claim 15, wherein a priority panel houses a first control circuit and the fueling station houses a second control circuit of the one or more control circuits, the first control circuit compiling the prediction model and the second control circuit activating the at least one compressor.

17. The method of claim 16, wherein the second control circuit activates a first compressor positioned downstream of the at least one subterranean sealed bore to supplement maintain the predetermined flow rate to a vehicle.

18. The method of claim 16, wherein the second control adjusts the predetermined flow rate to minimize pressure loss in the at least one subterranean sealed bore.

19. The method of claim 16, wherein the second control circuit opens a valve to at least one above ground tank to supplement delivery of natural gas from the at least one subterranean sealed bore.

20. The method of claim 15, wherein the prediction model comprises a gasoline gallon equivalent amount in the at least one subterranean sealed bore
